(19) United States
(12) Patent Application Publication
(10) Pub. No.: US 2009/0199303 A1
(43) Pub. Date: Aug. 6, 2009

(54) CE DEVICE MANAGEMENT SERVER, METHOD OF ISSUING DRM KEY BY USING CE DEVICE MANAGEMENT SERVER, AND COMPUTER READABLE RECORDING MEDIUM

(75) Inventors: Chang-sup AHN, Seoul (KR); Young-kuk YOU, Seoul (KR); Jun-bum SHIN, Suwon-si (KR); So-young LEE, Hwaseong-si (KR); Ji-young MOON, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/274,809

(22) Filed: Nov. 20, 2008

(30) Foreign Application Priority Data
Feb. 1, 2008 (KR) 10-2008-0010793

(51) Int. Cl. H04L 9/32

(52) U.S. Cl. 726/27

(57) ABSTRACT

Provided are a method of issuing a DRM (digital rights management) key by using a CE (consumer electronics) device management server. The method includes: authenticating the CE device; if authentication of the CE device succeeds, transmitting a request for issuing the DRM key to a key server for storing and managing the DRM key; receiving the DRM key from the key server; and transmitting the DRM key to the CE device. Thus, the CE device can conveniently and safely receive the DRM key.

### CROSS-REFERENCE TO RELATED PATENT APPLICATIONS

This application claims the benefit of Korean Patent Application No. 10-2008-0010793, filed on Feb. 1, 2008, in the Korean Intellectual Property Office, the disclosure of which is incorporated herein in its entirety by reference.

### BACKGROUND OF THE INVENTION

1. Field of the Invention

Apparatuses, systems and methods consistent with the present invention relate to issuing a digital rights management (DRM) key by using a consumer electronics (CE) device management server, and more particularly, to a CE device management server in which a DRM key for reproducing contents in which a CE device is protected by DRM is conveniently and safely issued, a method of issuing a DRM key by using a CE device management server, and a computer readable recording medium in which a program for executing the method is recorded.

2. Description of the Related Art

Multimedia contents such as music or movies etc. are provided through various businesses and mediums. A large number of multimedia contents are protected using DRM technology, and only a user who has paid for the right to use the contents can do so.

A CE device allows a processor to be built in an electronic device such as a video player, a television (TV), etc. and contents may be used through a network. There are various servers for providing contents on a network. The CE device may use services provided by these servers.

An apparatus for reproducing contents needs a unique identifier or a device key (hereinafter, referred to as a “DRM key”) so that DRM technology can be applied to the CE device. In the case of the CE device, the DRM key is generally installed in a corresponding device and is sold (for example, an advanced access content system (AACS) or digital transmission content protection (DTCP), etc.).

However, the CE device receives contents protected by DRM which are not mounted in the CE device, from a contents provider. In this case, there may be no problem in transmitting a DRM protocol module online. However, the DRM key needs to be secured more specifically. This is because the DRM key is important for classifying CE devices and is a means of accessing contents that are protected by DRM. Thus, there is a necessity for providing a method of transmitting a DRM key online while maintaining high security.

FIG. 1 illustrates a conventional method of issuing a key used in Internet banking.

Referring to FIG. 1, a public key infrastructure used in Internet banking etc. comprises a user 100, a registration agency organization 110, and an authentication organization 120.

First, the user 100 registers his/her identity at the registration agency organization 110 so as to be recognized. Next, the user 100 generates his/her own public key pairs. Next, the user 100 sends an authentication issuance request message in which a public key is included, to the registration agency organization 110 to request issuance of a certificate.

The registration agency organization 110 transfers the authentication issuance request message to the authentication organization 120, and the authentication organization 120 issues a certificate including a user's public key. The issued certificate is transferred to the user 100 and to a public directory server 130. An application service provider 140 may check the certificate issued to a user that has connected to the public directory server 130.

However, in the case of the CE device, the DRM key is issued by DRM technology such as an advanced access content system (AACS) or digital transmission content protection (DTCP). Thus, a system in which the CE device safely and conveniently receives the DRM key for reproducing contents protected by DRM, in various formats using the DRM technology, needs to be provided.

### SUMMARY OF THE INVENTION

The present invention provides a consumer electronics (CE) device management server in which a CE device allows a digital rights management (DRM) key for reproducing contents protected by DRM, in various formats to be conveniently and safely issued, a method of issuing a DRM key by using a CE device management server, and a computer readable recording medium in which a program for executing the method is recorded.

According to an aspect of the present invention, there is provided a method of issuing a DRM (digital rights management) key by using a CE (consumer electronics) device management server, the method including: receiving a request for issuing a DRM key which is used to access contents protected by DRM, from a CE device; authenticating the CE device; if authentication of the CE device succeeds, transmitting a request for issuing the DRM key to a key server for storing and managing the DRM key; receiving the DRM key from the key server; and transmitting the DRM key to the CE device.

The DRM key may be one of DRM keys provided to the key server from one or more DRM key providers.

The receiving of the request for issuing the DRM key may include receiving an identifier of the CE device from the CE device.

The DRM key and the request for issuing the DRM key may be transmitted or received in an encrypted format.

The request for issuing the DRM key may further include one of a time stamp, an electronic signature and a challenge-response protocol for preventing re-use of the DRM key.

The DRM key may further include a value for executing an integrity test.

The CE device may store a plurality of DRM keys for reproducing contents protected by DRM, in various formats.

The transmitting of the request for issuing the DRM key may include: if authentication of the CE device succeeds, checking whether a DRM key for reproducing contents protected by DRM, in the same format as an issuance-request DRM key has been issued or not; and selectively transmitting the request for issuing the DRM key based on an issuance history of the DRM key.

The transmitting of the request for issuing the DRM key may include: if the DRM key has been issued, checking whether the DRM key stored in the CE device that has requested the DRM key to be issued is revoked; and selectively transmitting the request for issuing the DRM key based on whether the DRM key stored in the CE device is revoked or not.

The key server may include a plurality of sub key servers, and the DRM key may be generated by combining data stored in each of the sub key servers.

According to another aspect of the present invention, there is provided a CE device management server including: a network connector which processes a network connection between the CE device management server and a key server storing and managing a DRM key which is used to access contents protected by DRM or between the CE device management server and the CE device; a key request processor which receives a request for issuing the DRM key from the CE device; and a device authenticator which authenticates the CE device if the request for issuing the DRM key is received from the key request processor, wherein the key request processor transmits the request for issuing the DRM key to the key server based on a result of authentication, receives the DRM key from the key server, and transmits the DRM key to the CE device.

According to another aspect of the present invention, there is provided a computer readable recording medium in which a program for executing a method of issuing a DRM (digital rights management) key by using a CE (consumer electronics) device management server, the method comprising: receiving a request for issuing a DRM key which is used to access contents protected by DRM, from a CE device; authenticating the CE device; if authentication of the CE device succeeds, transmitting a request for issuing the DRM key to a key server for storing and managing the DRM key; receiving the DRM key from the key server; and transmitting the DRM key to the CE device.

### BRIEF DESCRIPTION OF THE DRAWINGS

The above and other features and aspects of the present invention will become more apparent by describing in detail exemplary embodiments thereof with reference to the attached drawings in which:

FIG. 1 illustrates a conventional method of issuing a key used in Internet banking;

FIG. 2 illustrates a system for issuing a digital rights management (DRM) key according to an embodiment of the present invention;

FIG. 3 is a flowchart illustrating a method of issuing a DRM key by using a consumer electronics (CE) device management server according to an embodiment of the present invention;

FIG. 4 is a flowchart illustrating an operation of transmitting a request for issuing a DRM key to a key server by using the CE device management server of FIG. 3; and

FIG. 5 is a block diagram illustrating the configuration of a CE device management server and a key server according to an embodiment of the present invention.

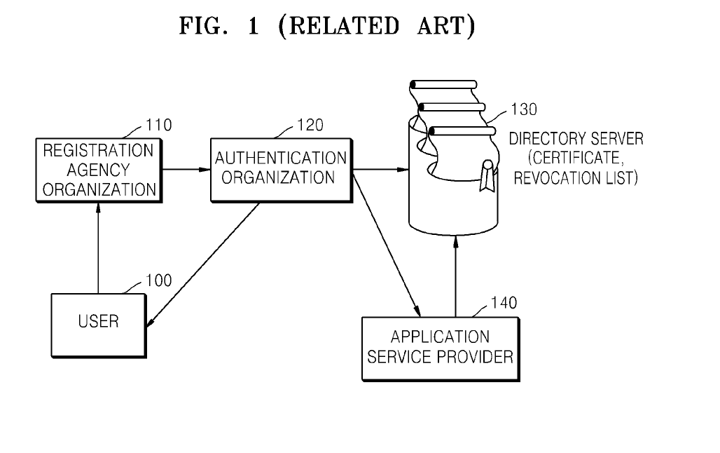

### DETAILED DESCRIPTION OF THE INVENTION

The present invention will now be described more fully with reference to the accompanying drawings, in which exemplary embodiments of the invention are shown.

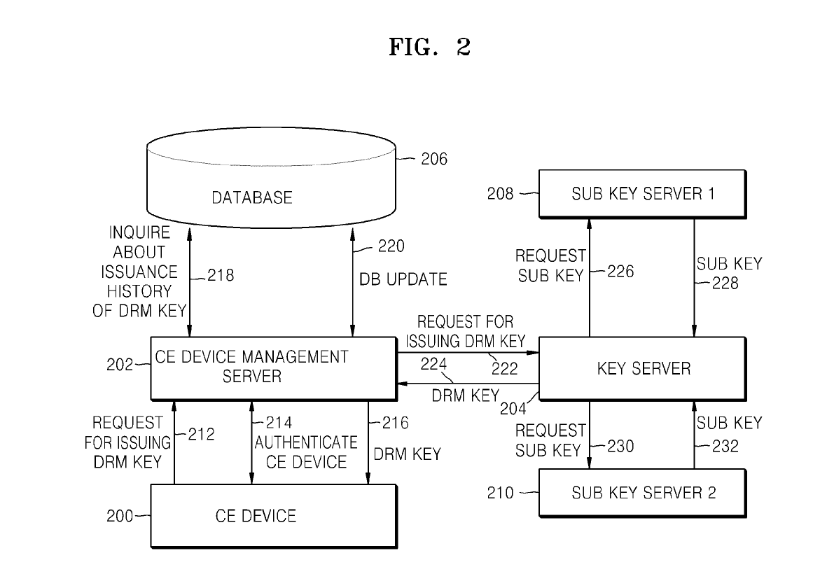

FIG. 2 illustrates a system for issuing a digital rights management (DRM) key according to an embodiment of the present invention.

Referring to FIG. 2, the system for issuing a DRM key comprises a consumer electronics (CE) device 200, a CE device management server 202, and a key server 204.

The CE device 200 reproduces contents such as a video player, an audio player, a television (TV), and a game player etc. Only one CE device 200 is shown in FIG. 2. However, in actuality, a plurality of CE devices 200 may be connected to the CE device management server 202.

The CE device 200 is connected to a network and has a single identifier ID_Dev. The identifier ID_Dev is unique information allocated to the CE device 200 and is identification information for identifying the CE device 200 on a network. The CE device 200 is connected to the CE device management server 202 through the network.

The CE device management server 202 is a server for safely providing a DRM key to the CE device 200 which transmits a request for issuing the DRM key. The CE device management server 202 is a server which the CE device 200 has access to. The CE device management server 202 checks whether the CE device 200 has a right to use the DRM key or not. The CE device management server 202 receives the DRM key that is stored and managed in the key server 204 and transmits the DRM key to the CE device 200.

The key server 204 is a server for safely storing and managing one or more DRM keys that have been previously purchased using DRM technology. The key server 204 transmits the DRM key that has been requested for issuance to the CE device management server 202. In a modified embodiment, the key server 204 may be implemented to purchase the DRM key from a DRM server (not shown) when there is a key issuance request from the CE device 200.

The sequence for issuing the DRM key is as follows.

The CE device 200 is connected to the CE device management server 202 and utilizes a safe communication channel such as a Secure Sockets Layer/Transport Layer Security (SSL/TLS) or a virtual private network (VPN) to make eavesdropping impossible and mutual authentication possible. The CE device 200 and the CE device management server 202 may share secret information such as a public key certificate or a password in advance, so as to set a safe communication channel and to authenticate the other party.

The CE device 200 transmits a request for issuing a DRM key including the unique identifier ID_Dev to the CE device management server 202 (operation 212).

The CE device management server 202 which has received the request for issuing the DRM key, authenticates the CE device 200 by using the identifier ID_Dev or encryption key authentication. If it is determined that the CE device 200 has detected security breaches and is not safe, the authentication of the CE device 200 fails and the CE device management server 202 stops issuance of the DRM key.

The sequence of operation 212 of transmitting the request for issuing the DRM key and operation 214 for authenticating the CE device 200 may be changed according to embodiments.

Next, if the authentication of the CE device 200 succeeds, the CE device management server 202 requests the key server 204 to issue the DRM key (operation 222) and receives the DRM key provided from the key server 204 (operation 224).

Next, the CE device management server 202 transmits the DRM key received from the key server 204 to the CE device 200 (operation 216). The CE device 200 stores and uses the received DRM key safely.

The DRM key must be transmitted in an encrypted format that can be decrypted by the CE device 200 to the CE device 200. For example, the DRM key may be encrypted using a secret key of the CE device 200 and may be transmitted. In addition, the DRM key may also be encrypted using Secure/Multipurpose Internet Mail Extensions (S/MIME) and may also be transmitted. Encryption of the DRM key may be performed by the CE device management server 202 or the key server 204.

In addition, in order to prevent a replay attack by a hacker, in operations 212 and 222 of requesting issuance of the DRM key, a time stamp, electronic signature or a challenge-response protocol etc. may be used together with the safe communication channel. In addition, a value for executing a data integrity test such as SHA-1 may be included in operations 216 and 224 of transmitting and receiving the DRM key.

The CE device 200 may store a plurality of DRM data and DRM keys corresponding to the plurality of DRM data simultaneously and may delete a part of the plurality of DRM data or DRM keys. The CE device 200 may receive re-issued DRM data and DRM key thereof. A DRM key transmitted in an operation of re-issuance may be the same key as a previously issued DRM key.

When transmitting another request for issuing the DRM key, the CE device 200 checks whether the CE device management server 202 has issued the DRM key for reproducing contents protected by DRM, in the same format as the previously issued DRM key.

In order to check an issuance history of the DRM key, the data base 206 which records an issuance history of the DRM key, may be connected to the CE device management server 202. If the CE device management server 202 receives a request for issuing the DRM key from the CE device 200, it may inquire about an issuance history of the DRM key to the database 206 and may selectively transmit an issuance request of the DRM key to the key server 304 according to a result of the inquiry. As a result of the inquiry, when issuance of a new DRM key is not necessary, the CE device management server 202 may not perform a request for issuing the DRM key (operation 222) or may issue the same DRM key to the CE device 200. The CE device management server 203 may transmit the DRM key to the CE device 200 and then may update an issuance history of the DRM key to the database 206 (operation 220). However, time for updating the database 206 is not limited to time after the DRM key is transmitted to the CE device 200 (operation 220) and may also be performed even before transmitting the DRM key.

As another embodiment for preventing the case where the same DRM key is issued unnecessarily, the database 206 may also be connected to the key server 204.

If the security of the CE device 200 is weak and all data related to the DRM key is not safe, the CE device management service 202 must prevent the DRM key from being issued by the CE device 200. Thus, the CE device management sever 202 stops issuance of the DRM key when, as a result of authenticating the CE device 200 by using the identifier ID_Dev or performing encryption authentication, it is determined that the CE device 200 has detected security breaches and is not safe, and the authentication has failed.

In addition, the CE device 200 is normal. However, due to leakage of the stored DRM key or contents related to a media key block (MKB) used in broadcasting encryption, the DRM key may be replaced with another key. In this case, the CE device management server 202 revokes the DRM key that cannot be used any longer and requests the key server 204 for a new DRM key. The CE device management server 202 checks whether the previous DRM key, which is stored in the CE device 200 that requests the new DRM key to be issued, is a revoked key. Only when the previous DRM key is a revoked key does the CE device management server 202 transmit a request for the DRM key to be issued, to the key server 204. The CE device management server 202 may be connected to the database 206 for storing information about whether the DRM key is revoked or not, so as to check whether the DRM key stored in the CE device 200 is revoked or not. Information about whether the DRM key is revoked or not may be provided by a manufacturer of the CE device 200 or a DRM management organization, etc.

In addition, the key server 204 may further comprise a plurality of sub key servers 208 and 210 to improve safety with respect to the prevention of hacking in the operation of issuing a DRM key. Each of the sub key servers 208 and 210 may store part of a DRM key (i.e., a sub key) which is not a complete DRM key. The key servers 204 request the sub key servers 208 and 210 of sub keys and combine the sub keys received from the sub key servers 208 and 210 to constitute a DRM key.

For example, the DRM key may be a value obtained by combining a sub key 1 and a sub key 2 by using an exclusive OR (XOR) gate, a value obtained by inputting a one-way hash function to the sub key 1 and the sub key 2 or a value obtained by encrypting the sub key 1 by using the sub key 2 as a symmetrical key. In addition, as a modified embodiment, the CE device management server 202 may directly request the sub key servers 208 and 210 of sub keys and may combine the received sub keys to generate a DRM key.

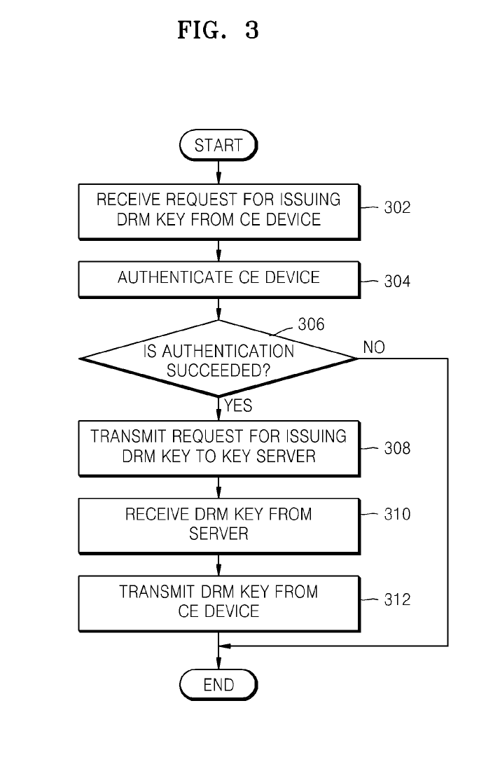

FIG. 3 is a flowchart illustrating a method of issuing a DRM key by using a CE device management server according to an embodiment of the present invention. Referring to FIG. 3, in operation 302, the CE device management server receives a request for issuing a DRM key including an identifier of a CE device from the CE device. A request for issuing the DRM key may be received in an encrypted format. A request for issuing the DRM key may include a time stamp, an electronic signature or a change-response protocol, so as to prevent a hacker's re-use of the DRM key.

In operation 304, the CE device management server which has received the request for issuing the DRM key, authenticates the CE device which has received the request for issuing the DRM key. The CE device management server authenticates the CE device by checking whether the CE device has a right of use or not.

In operation 306, if authentication of the CE device fails, the CE device management server terminates the process for issuing the DRM key. In addition, if authentication of the CE device succeeds in operation 306, the CE device management server transmits the request for issuing the DRM key to the key server which stores and manages the DRM key, in operation 308. The key server stores at least one DRM key provided by one or more DRM key providers.

In operation 310, the CE device management server receives the DRM key from the key server. The DRM key may be received together with a value for executing an integrity test. In addition, the DRM key may be received in an encrypted format. In addition, the key server may comprise a plurality of sub key servers, and in this case, the DRM key may be generated by combining sub keys stored in each of the sub key servers.

In operation 312, the CE device management server transmits the DRM key to the CE device. The CE device which has received the DRM key may store a plurality of DRM keys for reproducing contents protected by DRM in various formats simultaneously.

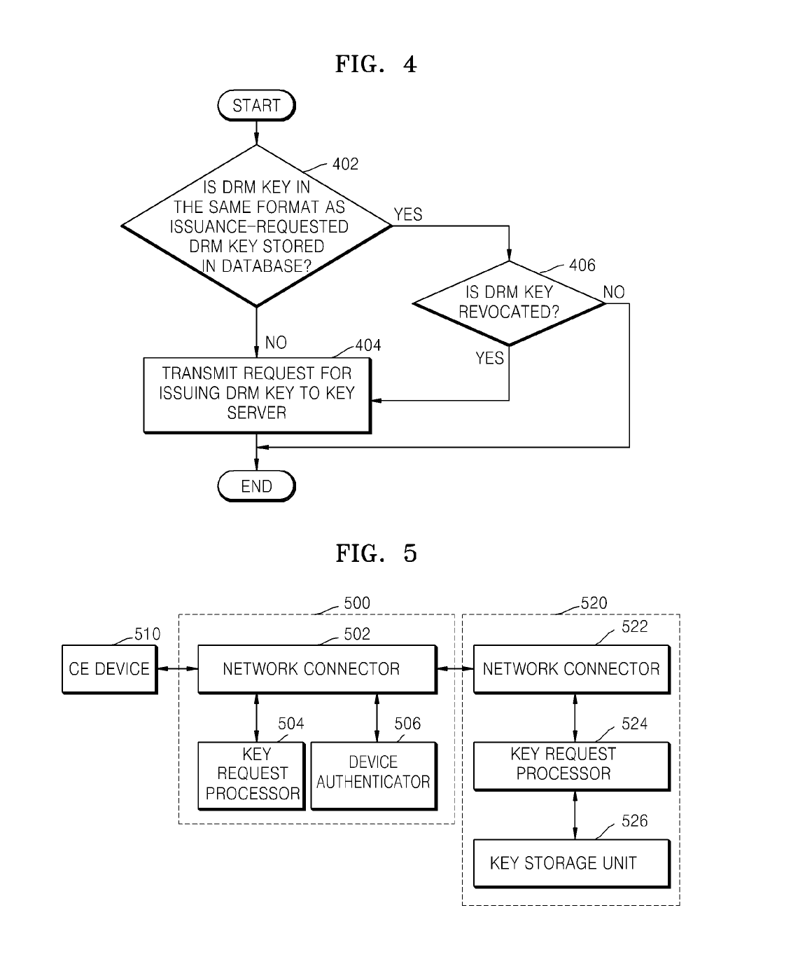

FIG. 4 is a flowchart illustrating an operation of transmitting a request for issuing a DRM key to a key server by using the CE device management server of FIG. 3. Referring to FIG. 4, in operation 402, the CE device management server checks whether a DRM key, which is for reproducing contents protected by DRM, in the same format as an issuance-requested DRM key, is stored in a database or not. As a result of the checking, if a DRM key having the same format as the issuance-requested DRM key, i.e., the requested DRM key, is not stored in the database, in operation 404, the CE device management server transmits the request for issuing the DRM key to the key server. However, if a stored DRM key having the same format as the requested DRM key, is stored in the database, in operation 406, the CE device management server checks whether the stored DRM key is a revoked key or not. As a result of the checking, if the stored DRM key is a revoked key, the CE device management server transmits the request for issuing the DRM key to the key server. If the stored DRM key of the CE device which has requested the new DRM key to be issued, is not a revoked key, the CE device management server terminates the process.

FIG. 5 is a block diagram illustrating the configuration of a CE device management server and a key server according to an embodiment of the present invention. Referring to FIG. 5, the CE device management server 500 comprises a network connector 502, a key request processor 504, and a device authenticator 506.

The network connector 502 processes a network connection between the CE device management server 500 and a key server 520 for storing and managing a DRM key used to access contents protected by DRM, or between the CE device management server 500 and a CE device 510.

The key request processor 504 receives a request for issuing the DRM key via the network connector 502 from the CE device 510. The key request processor 504 transmits the request for issuing the DRM key to the key server 520 based on a result of authentication of the device authenticator 506, receives the DRM key from the key server 520, and transmits the DRM key to the CE device 510 via the network connector 502.

The key request processor 504 may receive an identifier of the CE device 510 from the CE device 510. In addition, if authentication of the CE device 510 succeeds, the key request processor 504 may check whether the CE device 510 has issued a DRM key for reproducing contents protected by DRM, in the same format as an issuance-requested DRM key, and may transmit the request for issuing the DRM key selectively based on an issuance history of the DRM key.

In addition, if there is an issuance history of the DRM key, the key request processor 504 may check whether the DRM key stored in the CE device 510 is a revoked key or not and may transmit a request for issuing a new DRM key selectively based on a result of the checking.

The device authenticator 506 performs authentication of the CE device 510 when the request for issuing the DRM key is received from the key request processor 504.

The key server 520 comprises a network connector 522 for processing a network connection with the key server 520, a key request processor 524 for processing a request for issuing a DRM key of the CE device management server 500, and a key storage unit 526 for storing DRM keys.

The key server 520 may be connected to a plurality of sub key servers. In this case, the DRM key is generated by combining sub keys stored in the sub key servers.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. In other exemplary embodiments, the examples of computer readable recording medium may include carrier waves (such as data transmission through the Internet) and the computer readable recording medium can also be distributed over network coupled computer systems so that the computer readable code is stored and executed in a distributed fashion.

According to the present invention, a DRM key is issued to a CE device by using a CE device management server so that the CE device allows the DRM key for reproducing contents protected as DRM, in various formats so as to be conveniently and safely issued.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of issuing a digital rights management (DRM) key by using a consumer electronics (CE) device management server, the method comprising:
receiving a request for issuing a DRM key corresponding to contents protected by DRM, from a CE device;
authenticating the CE device in an authentication;
if the authentication of the CE device succeeds, transmitting a request for issuing the DRM key, to a key server which stores and manages the DRM key;
receiving the DRM key from the key server; and
transmitting the DRM key to the CE device.

2. The method of claim 1, wherein the DRM key is one of a plurality of DRM keys provided to the key server from one or more DRM key providers.

3. The method of claim 1, wherein the receiving of the request for issuing the DRM key comprises receiving an identifier of the CE device from the CE device.

4. The method of claim 1, wherein the DRM key and the request for issuing the DRM key are transmitted or received in an encrypted format.

5. The method of claim 1, wherein the request for issuing the DRM key comprises one of a time stamp, an electronic signature and a challenge-response protocol for preventing re-use of the DRM key.

6. The method of claim 1, wherein the DRM key comprises a value for executing an integrity test.

7. The method of claim 1, wherein the CE device stores a plurality of DRM keys corresponding to contents protected by DRM, in a plurality of formats.

8. The method of claim 1, wherein the transmitting of the request for issuing the DRM key comprises:
if the authentication of the CE device succeeds, checking whether the DRM key was previously issued or not to determine an issuance history of the DRM key; and
selectively transmitting the request for issuing the DRM key based on the issuance history of the DRM key.

9. The method of claim 8, wherein the transmitting of the request for issuing the DRM key comprises:
if the DRM key was previously issued, checking whether the DRM key stored in the CE device is revoked; and
selectively transmitting the request for issuing the DRM key based on whether the DRM key stored in the CE device is revoked or not.

10. The method of claim 1, wherein the key server comprises a plurality of sub key servers, and the DRM key is generated by combining data stored in each of the sub key servers.

11. A consumer electronics (CE) device management server comprising:
a network connector which processes a network connection with a key server which stores and manages a DRM key corresponding to contents protected by DRM, or with the CE device;
a key request processor which receives a request for issuing the DRM key from the CE device; and
a device authenticator which authenticates in an authentication, the CE device if the request for issuing the DRM key is received from the key request processor,
wherein the key request processor transmits the request for issuing the DRM key to the key server based on a result of the authentication, receives the DRM key from the key server, and transmits the DRM key to the CE device.

12. The CE device management server of claim 11, wherein the DRM key is one of a plurality of DRM keys provided to the key server from one or more DRM key providers.

13. The CE device management server of claim 11, wherein the key request processor receives an identifier of the CE device from the CE device.

14. The CE device management server of claim 11, wherein the DRM key and the request for issuing the DRM key are transmitted or received in an encrypted format.

15. The CE device management server of claim 11, wherein the request for issuing the DRM key comprises one of a time stamp, an electronic signature and a challenge-response protocol for preventing re-use of the DRM key.

16. The CE device management server of claim 11, wherein the DRM key comprises a value for executing an integrity test.

17. The CE device management server of claim 11, wherein the CE device stores a plurality of DRM keys corresponding to contents protected by DRM, in various formats.

18. The CE device management server of claim 11, wherein the key request processor, if authentication of the CE device succeeds, checks whether the DRM key was previously issued or not to determine an issuance history of the DRM key, and selectively transmits the request for issuing the DRM key based the issuance history of the DRM key.

19. The CE device management server of claim 18, wherein the key request processor, if the DRM key has been issued, checks whether the DRM key stored in the CE device is revoked or not, and selectively transmits the request for issuing the DRM key based on whether the DRM key stored in the CE device is revoked or not.

20. The CE device management server of claim 11, wherein the key server comprises a plurality of sub key servers, and the DRM key is generated by combining data stored in each of the sub key servers.

21. A computer readable recording medium in which a program for executing a method of issuing a digital rights management (DRM) key by using a consumer electronics (CE) device management server, the method comprising:
receiving a request for issuing a DRM key corresponding to contents protected by DRM, from a CE device;
authenticating the CE device;
if authentication of the CE device succeeds, transmitting a request for issuing the DRM key to a key server which stores and manages the DRM key;
receiving the DRM key from the key server; and
transmitting the DRM key to the CE device.
